(19) United States
(12) Patent Application Publication
(10) Pub. No.: US 2008/0223232 A1
(43) Pub. Date: Sep. 18, 2008

(54) Process for Producing a Carrier Material with Hidden Identification Marks

(75) Inventors: Lambert Nekula, Hofstetten (AT); Marco Dircetti, Vicenza (IT); Franz Reiterer, Getzersdorf (AT); Adolf Schedl, Obergrafendorf (AT)

Correspondence Address: YOUNG & THOMPSON, 209 Madison Street, Suite 500, ALEXANDRIA, VA, 22314, US

(73) Assignee: TEICH AKTIENGESELLSCHAFT, WEINBURG (AT)

(21) Appl. No.: 11/994,650

(22) PCT Filed: Jun. 22, 2006
(86) PCT No.: PCT/AT2006/000254

§ 371 Date: Feb. 29, 2008

(30) Foreign Application Priority Data
Jul. 4, 2005 (AT) A 1126/2005

(51) Int. Cl. B44C 1/24

(52) U.S. Cl. 101/32

(57) ABSTRACT

The invention relates to a process for producing a carrier material with at least one hidden identification mark which is attached in at least one surface region of the carrier material and which is then covered. The invention furthermore relates to articles containing this carrier material and its use for analysis of the identification mark(s). By the process as claimed in the invention a carrier material with hidden identification marks is made available, the use of which is given in a wide range, especially when the original state of goods is to be established. For the consumer itself the identification mark is not necessarily visible so that he is not unnecessarily upset, but rather is confronted with a conventional decoration, specifically an embossing pattern. If necessary, such as for example in customs controls, the identification mark however can be easily exposed by depression so that analysis of the packaged product with respect to originality can take place.

The invention relates to a process for producing a carrier material with at least one hidden identification mark which is attached in at least one surface region of the carrier material and which is then covered. The invention furthermore relates to articles containing this carrier material and its use for analysis of the identification mark(s).

Applying identification marks to carrier materials, for example packaging foils, in order to protect occasionally sensitive packaged articles such as pharmaceuticals against counterfeits, is known. EP A1 1 150 270 suggests a metal-coated paper with a security feature worked into it which is formed by the metal layer on the main surface acquiring a different appearance compared to selected partial areas due to differences in the compositions of the varnishes used. In barknotes or credit cards there has been a transition to providing them with quite complex holograms. In this connection it has been found that holograms in spite of their complex production, with increasing technical development can likewise be counterfeited.

According to WO A1 03/104891 the applicant has now suggested, in the course of the packaging process, announcing the counterfeit-proof identification features to a simply limited circle of individuals which it can identify without the need to be technically active in an above average manner for its business or the product to be packaged and it can characterize subsequently. In this connection packaging foils are structured in a given partial region such that by the corresponding light refraction the identification mark becomes visible to the viewer. For highly sensitive products such as pharmaceuticals for example, a visible identification mark is a quite acceptable circumstance for the end consumer and also for the packager. In any case it has been found that for mass-market products, for example cigarettes which however are likewise to be protected against counterfeits, possible visible identification marks could unnecessarily upset the consumer. According to WO A1 03/104890 therefore the identification mark is first made invisible with a covering varnish so that it is only made visible for one skilled in the art upon further use. In any case the removal of the covering varnish later can make further checking with respect to genuineness of the product difficult.

Therefore the object of this invention is to improve the initially mentioned processes such that the genuineness of the product can be easily checked using hidden identification marks not only for specialists.

As claimed in the invention, therefore a process of the initially named type is suggested which is characterized in that covering of the identification mark(s) (3) takes place by embossing.

Other advantageous embodiments of the process as claimed in the invention are disclosed according to the dependent claims. The invention furthermore relates to articles such as cigarette foils or packaging foils for foods such as chocolate, containing the carrier material which has been produced as claimed in the invention. The invention furthermore relates to use of these articles for analysis of the identification marks, the embossed regions advantageously being depressed by slight pressure, such as finger pressure.

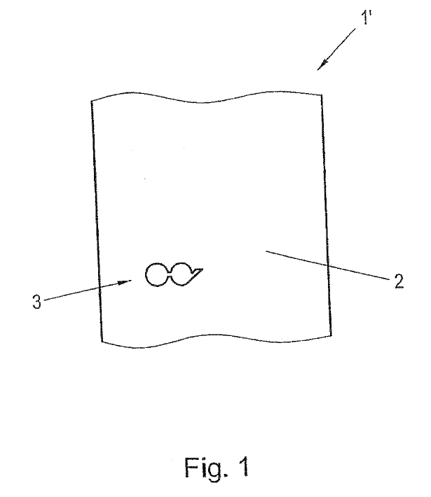

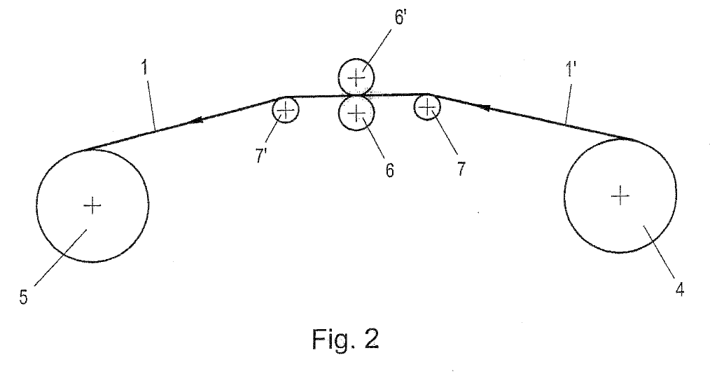

The invention is detailed below using FIGS. 1 and 2 and based on one possible embodiment for executing the invention.

FIG. 1 shows an intermediate product I′ which has the identification mark 3 in visible form, conversely

FIG. 2 reproduces a sample diagram of the process as claimed in the invention for covering the identification marks 3.

One possible approach to implementation of the invention is detailed below.

A parent product for the process as claimed in the invention is for example an aluminum foil which is provided with the identification mark 3, for example a company logo. This can take place by coating with conventional printing ink systems, the identification mark 3 being partially applied or applied in a distributed manner uniformly over the entire surface.

Furthermore it is possible to apply the identification mark 3 by means of laser technology. In the region 3 structuring with an intensity depending on the irradiation can be produced by the amount of irradiation.

Furthermore it is also possible to apply the identification mark 3 by means of working rolls which act at the same time as embossing rolls. In particular, aluminum foils are brought to the desired layer thickness for their further use by rolling. This takes place by working rolls between which the aluminum foil is guided. Not only can the desired foil thickness be set by the pressure in the roll gap, but at the same time an identification mark can be transferred to the foil surface. For this purpose the surface of the working rolls is treated by means of laser technology. The shape of the identification mark which is engraved into the foil surface during rolling can be produced on the roll surface by specific irradiation.

At this point the carrier material can be provided with a colored coating system before or after applying the identification mark. It is important in this connection that the coating system is only slightly pigmented so that coloring is achieved, but the identification mark can be made visible at any time.

Regardless of the two-dimensional carrier materials such as foils, the identification mark 3 can be applied by the aforementioned processes likewise to two-dimensional carrier materials such as labels.

In a farther process step, the identification mark 3 is covered. This takes place by an embossing process since embossing patterns for the consumer, for example in the case of cigarette foils, constitute a quite conventional phenomenon. By embossing the intermediate product 1′ shown in FIG. 1, at this point the identification mark 3 becomes no longer visible to the consumer. A corresponding embossing process is shown in FIG. 2. In this connection the intermediate product 1′ is supplied from a delivery roll 4 via a deflection roll 7 to the embossing roll pair 6, 6′. The pressure applied by the embossing rolls yields a uniform embossing pattern also in the region of the identification mark 3 so that it is hidden to the viewer, therefore is no longer visible. Via a further deflection roll 7′ the packaging foil with the hidden identification mark 3 is supplied to a take-up roll 5. From the latter at this point the packaging material produced as claimed in the invention can be withdrawn and used for farther applications. This takes place for example by lamination; this is especially important in a use as cigarette foil or packaging foil for foods.

Since in the meantime mass-market articles such as cigarettes must also be protected against counterfeits, if necessary the identification mark 3 can be made visible at this time. This takes place for example within the framework of customs control by analysis of the packaging materials in which the identification mark 3 can be exposed by application of only low pressure, therefore by depression. This means that the identification mark is effaced simply by finger pressure or wiping and is thus made detectable. Thus at least a first check whether quality goods or counterfeits are present can be done without complex measurement engineering measures.

In summary, it can be stated that by the process as claimed in the invention a carrier material with hidden identification marks is made available, the use of which is given in a wide range, especially when the original state of goods is to be established. For the consumer himself the identification mark is not necessarily visible so that he is not unnecessarily upset, but rather is confronted with a conventional decoration, specifically an embossing pattern. If necessary, such as for example in customs controls, the identification mark however can be easily exposed by depression so that analysis of the packaged product with respect to originality can take place.

1-16. (canceled)

17. Process for producing a packaging foil of aluminum with at least one hidden identification mark (3) which is attached in at least one surface region (2) of the aluminum packaging foil and which is then covered, characterized in that covering of the identification mark(s) (3) takes place by embossing.

18. Process as claimed in claim 17, wherein the identification mark (3) is applied by laser technology.

19. Process as claimed in claim 17, wherein the identification mark (3) is applied by means of structured embossing rolls.

20. Process as claimed in claim 19, wherein the embossing rolls are structured by means of laser technology.

21. Process as claimed in claim 17, wherein the identification mark (3) is applied by coating.

22. Process as claimed in claim 17, wherein the identification marks (3) are located uniformly on the entire surface of the carrier material.

23. Process as claimed in claim 17, wherein the aluminum packaging foil is provided with a colored, noncovering coating system.

24. Cigarette foil encompassing an aluminum packaging foil with one or more hidden identification marks (3) produced as claimed in claim 17.

25. Cigarette foil as claimed in claim 24 for analysis purposes, wherein the identification mark(s) (3) are made visible by depression.

26. Cigarette foil as claimed in claim 25, wherein depressing takes place by slight pressure application, such as finger pressure.

27. An aluminum packaging foil produced by the process of claim 17 for packaging of foods such as chocolate.
